(19) United States
(12) Patent Application Publication
(10) Pub. No.: US 2003/0035444 A1
(43) Pub. Date: Feb. 20, 2003

(54) Method for synchronizing a communication system via a packet-oriented data network

(75) Inventor: Eduard Zwack, Puchheim (DE)

Correspondence Address: STAAS & HALSEY LLP, 700 11TH STREET, NW, SUITE 500, WASHINGTON, DC, 20001, US

(73) Assignee: Siemens AG, Munchen (DE)

(21) Appl. No.: 10/214,938

(22) Filed: Aug. 9, 2002

(30) Foreign Application Priority Data
Aug. 9, 2001 (DE) 101 39 143.9

(51) Int. Cl. H04J 3/06

(52) U.S. Cl. 370/503; 375/354

(57) ABSTRACT

To synchronize a communication system via a packet-oriented data network, a frequency offset of a time-measuring device is determined by a measuring device using only data packets with approximately the same forward and return times.

### CROSS REFERENCE TO RELATED APPLICATIONS

This application is based on and hereby claims priority to German Application No. 101 39 143.9 filed on Aug. 9, 2001, the contents of which are hereby incorporated by reference.

### BACKGROUND OF THE INVENTION

1. Field of the Invention

The invention relates to a method for synchronizing a communication system via a packet-oriented data network by a measuring device for determining a frequency offset, and a transceiver device and a network device.

2. Description of the Related Art

Voice connections in telecommunications networks have hitherto been set up in a predominantly connection-oriented manner. To do this, a line, which is reserved for the entire duration of the voice connection, is provided for signal transmission between two communication end points. This type of telecommunications connection is also referred to as a circuit-switching telecommunications network.

The emergence of packet-oriented data networks, e.g. the Internet, has enabled relatively low-cost communications compared with circuit-switching telecommunications. This is due in particular to the improved usability of a connection, since the resources available in a telecommunications network, particularly transmission capacities, can be utilized far more efficiently by packet-oriented transmission (packet switching) than is possible with circuit switching.

VoFR (Voice over Frame Relay) or VoIP (Voice over IP), for example, are known as packet-oriented transmission methods for voice. Here, voice data are digitized, subjected to source coding and preferably channel coding and distributed among data packets, which are then transferred via the Internet. VoIP in particular is predicted to be of substantial importance for future voice communications.

However, in the transmission of voice data using packet-oriented transmission methods, the problem arises that a transit time of the data packets transporting the voice data can be substantially higher than in conventional telephony, and that the transit times of adjacent data packets vary significantly, so that they can no longer be combined in the receiving device in virtually real time.

This normally results in delays (jitter) or even failure of the voice connection, and, in the worst case, the voice connection may even break down completely. In the public telephone network, the delay times are 20-30 ms, whereas they can exceed 500 ms in VoIP networks. Voice compression and packet assembly waiting time, inter alia, are responsible for these transit time differences. However, synchronization errors also represent a further substantial cause of these transit time differences.

An essential requirement for reducing these transit time differences is therefore exact synchronization of the communication system within the data network. To do this, the system times of the end points involved in the communications must correspond exactly. An Network Time Protocol (NTP) is typically used to synchronize the system times. The NTP protocol is implemented by synchronized time servers, which are located at different points on the Internet. This protocol was specified in RFC 1305.

The resulting common time basis is used for time-critical processes, particularly in Internet telephony. The time servers are hierarchically related to one another. A secondary time server obtains its time via the data network from a primary time server, while other time servers in turn obtain their time from the secondary time server. The synchronization between a transceiver device and a time server runs in simplified form as follows:

The transceiver device transmits an NTP data packet with an NTP identifier at a time T1 to the time server, at which this data packet arrives at time T2. The server evaluates the incoming identifier within the data packet, exchanges the IP address and transmits the data packet at time T3 back to the device, where the data packet finally arrives at time T4. This method therefore produces four times (time stamps), from which a computer device within the transceiver device calculates a delay, i.e. the time during which the data packet with the NTP identifier was in transit in the network. An offset, i.e. the time span by which the clocks of the transceiver device and the time server differ, is also determined. Both variables are approximately determined from:

Delay=(T4−T1)−(T3−T2)

$$Offset = \frac{( T4 - T3 ) + ( T1 - T2 )}{2}$$

The formula for determining the offset reveals that the offset is only an averaging of the delay, i.e. this method assumes that the forward and return paths of the NTP data packets are of equal length. Deviations therefrom are incorporated as errors in the offset calculation. Only phase accuracies of maximum 1 ms can thus be achieved.

Accurate synchronization is also indispensable for trouble-free interworking of IP systems with “conventional” TDM systems.

### SUMMARY OF THE INVENTION

An object of the invention is to indicate a method for precise synchronization of the transceiver devices in a data network so that the transit times and, in particular, the transit time differences of temporally interrelated data packets are reduced to the extent that a high-quality voice connection is guaranteed, along with devices and components suitable for this purpose.

An essential aspect of the invention is that only data packets which have approximately the same forward and return transit times are used to determine a frequency offset of at least two data packets which have approximately the same delay. A frequency offset can thereby be very accurately determined without the occurrence of measurement errors due to inadequate averaging.

In a further design, only data packets with a short transit time are used to determine the frequency offset. From the current perspective, this transit time should be less than 5 ms. In a preferred design, the data packets are transported by corresponding transceiver devices via network nodes with integrated reference clocks, in particular NBCS reference clocks. In this design, each network node via which the data packets are transmitted therefore contains an NBCS reference clock. A delay variance, i.e. the data packet transit time, is reduced quite substantially due to this design. The transit time is maintained as constant due to integration of network nodes according to this design.

An extended Real Time Transport Protocol (RTP) is used to carry out the method and transport the data packets. Sufficient time data are therefore available to be evaluated for synchronization. A time stamp received by a receive station, a time stamp defined on reception and a time stamp generated on transmission are also added to the data packet.

The absolute accuracy of the time stamps should be greater than 125 microseconds. Measuring devices are preferably provided within the transceiver device which, in one design of the method, determine the frequency deviation of a time-measuring device disposed within the devices, and transmit an identifier to a tracking device depending on this frequency deviation. This tracking device then corrects the system time of the respective device depending on the frequency deviation.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram of a network device;

FIG. 2 is a block diagram of synchronization within a data network;

FIG. 3a is a block diagram of allocation of network nodes according to two state-of-the-art designs;

FIG. 3b is a block diagram of allocation of network nodes according to a design form of the invention;

FIG. 3c is a graph of delay variances depending on the arrangement of the network nodes;

FIG. 4 are graphs for determining a frequency offset;

FIG. 5 is a record layout of an extended RTP data packet, and

FIG. 6 is a block diagram of determining and correcting a frequency deviation.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

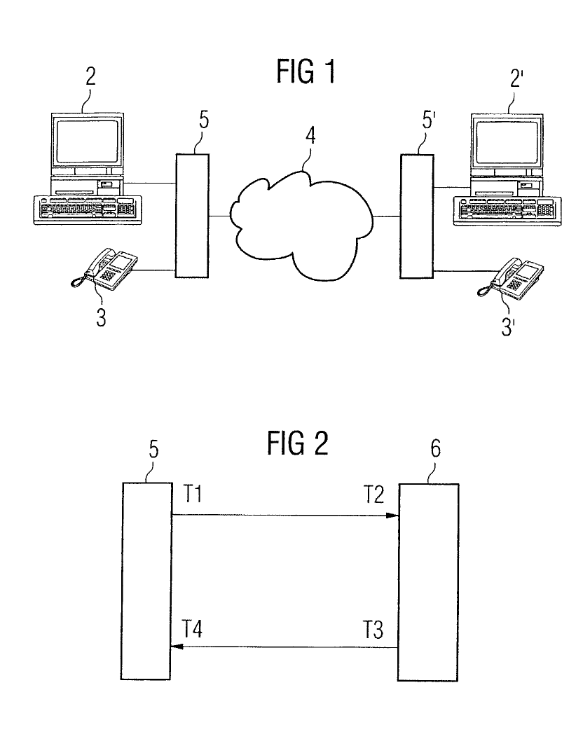

FIG. 1 is a block diagram of a system including a network device 1 for networking data processing devices 2, 2′ or telecommunications terminal devices 3, 3′ via a packet-oriented data network 4, e.g. the Internet. The devices are connected to transceiver devices 5, 5′ which set up a connection to the packet-oriented data network 4.

The transmission of voice data via the packet-oriented data network 4 is becoming increasingly important in telecommunications. In contrast to circuit switching, no permanent seizure of a channel is undertaken during a call with this communication method, but, in communications also referred to as “Internet telephony”, voice is digitized, compressed and distributed among a plurality of data packets for transmission. Each data packet is provided with a header containing all the switching-related information. This information includes in particular address information of the receiver and sender, and also instructions for dispatch to the relevant receiver. Within the packet-oriented data network 4, data packet switching takes place in which the data are switched in packets via subpaths from one network node to the next. The individual packets are then recombined in the receiver to form an original data stream.

There are several possibilities for the technical implementation of voice communications via the data network 4. In a first design, two parties to a call can phone one another via two data processing devices 2, 2′ connected to the Internet. In each case, these devices digitize the voice signals and reduce the data volume by voice compression. To set up a connection, the calling party must know the IP address of the called party. However, many Internet users have no fixed IP address, since their service provider dynamically allocates an IP address to them at each login. It is therefore very inconvenient to initiate a telephone call in this way. Furthermore, only persons who are currently “online” can be contacted.

A second variant is provided by communication between the data processing device 2 (2′) and the telecommunications terminal device 3′ (3), in which the call data enter the normal telephone network (PSTN) at a point in the data network 4. This function is performed in this design by a gateway 5′ (5).

A third, and the most convenient, possibility for IP telephony is the direct connection of the terminal device 3 to the terminal device 3′. Two gateways 5, 5′, which should be positioned as close as possible to the terminal devices 3, 3′, are required for this purpose.

FIG. 2 shows a design for synchronizing a system clock of the transceiver 5, 5′ according to the state of the art.

The aforementioned NTP protocol is implemented by synchronized time servers 6, which are located at different points on the Internet. This protocol was specified in RFC 1305. The resulting common time basis is used for time-critical processes, particularly in Internet telephony. The time servers 6 are hierarchically related to one another. The synchronization between the transceiver device 5, 5′ and the time server 6 runs in simplified form as follows:

The transceiver device 5 transmits an NTP data packet with an NTP identifier at a time T1 to the time server 6, at which this data packet arrives at time T2. The server evaluates the incoming identifier within the data packet, exchanges the IP address and transmits the data packet at time T3 back to the device 5, where the data packet finally arrives at time T4. This method therefore produces four times (time stamps), from which a measuring device within the transceiver device 5, 5′ calculates a delay, i.e. the time during which the data packet with the NTP identifier was in transit in the network.

Furthermore, a frequency offset, i.e. a time span by which the clocks of the transceiver device 5, 5′ and the time server 6 differ, is also determined. Both variables are approximately determined from:

Delay=(T4−T1)−(T3−T2)

$$Offset = \frac{( T4 - T3 ) + ( T1 - T2 )}{2}$$

In the present design of the method according to the invention, only the data packets transmitted between the transceiver 5, 5′ and the time server 6 which have the same forward transit time (T2−T1) and return transit time (T4−T3) are used for synchronization. Advantageous design forms for precise determination of the forward and return transit times are explained in detail in embodiments below.

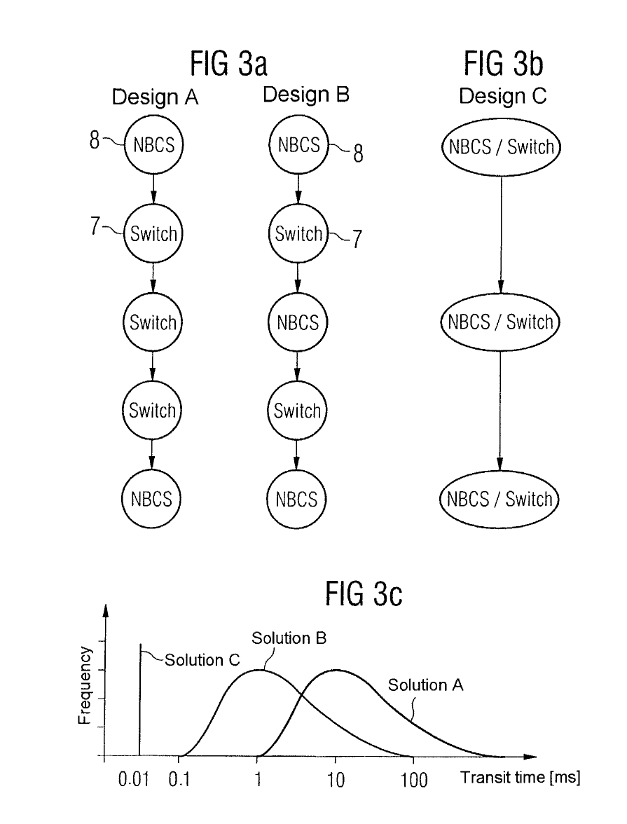

FIG. 3a shows two arrangements of network nodes 7 and reference clocks 8 within the data network 4 in a design according to the state of the art.

Many different requirements are imposed on a voice network. One essential requirement is a virtually real-time response in the transmission of the data packets transporting the voice data. Speech is a continuous process and it goes totally against its nature to be split up into packets. Telephony is therefore the classic example of a real-time application. Here, the delay times in data transport must be minimal, since human hearing would otherwise detect them and the parties involved would regard them as unacceptable faults. Similarly, it must be ensured that the packets are received in the correct sequence in the receiver, since otherwise the transmitted speech components would no longer be meaningful. Only when these two interference factors are minimized can a minimum level of speech quality be guaranteed without other data transmissions being severely impaired.

These requirements cannot be met by the IP protocol alone, so that additional mechanisms must be implemented in order to guarantee Quality of Service (QoS). The speech quality of a VoIP connection is determined by the following criteria:

Transit time of the voice signal

Loss of individual voice segments

Use of voice compression

Various factors are responsible for the fact that the transit time in voice connections via the IP protocol may be substantially higher than in conventional telephony. Voice compression and the waiting time in packet assembly, inter alia, are responsible for this. Furthermore, the buffer storage of the packets in the network nodes 7, particularly with high network load, delays their forwarding and therefore impairs speech quality. In the public telephone network, the delay times are 20-30 ms, whereas they can exceed 500 ms in VoIP networks. Since the IP protocol operates in a connectionless manner, all voice packets do not follow the same path through the network. “Jitter” is thus created, which means that the intervals between the packets are no longer the same length.

Reference clocks 8 are already provided in the data network 4 to compensate for these waiting times. NBCS (Network Based Communication System) reference clocks 8 are increasingly used in present-day data network architectures. In the design A shown in FIG. 3a, a plurality of network nodes 7 are disposed between two NBCS reference clocks 8, thus creating long transmission paths for synchronization.

In the design B shown in FIG. 3a, NBCS reference clocks 8 are disposed in each case between the individual network nodes 7. The data packets are thus routed more frequently via the reference clocks, thereby producing smaller delay variances during synchronization. For this reason, a Phase Locked Loop (PLL) disposed within the network nodes can perform faster control.

FIG. 3b shows an arrangement of network nodes 7 according to one design of the invention. In this design, network nodes 7 and NBCS reference clocks 8 are disposed within a device. These devices are directly interconnected with no further network nodes being disposed between them. The resulting transit time differences in transporting data packets via a network 4 of this design are thus very much smaller. Furthermore, in this design, the transit time delay is maintained as constant due to integration of network components.

The diagram in FIG. 3c shows the delay variances in an arrangement of the network nodes 7 and the NBCS reference clocks 8 according to the state of the art (FIG. 3a) and in a system according to the invention (FIG. 3b).

The diagram in FIG. 3c shows a schematic representation of the frequency distribution of the data packets depending on the transit time. It is evident that the arrangement of network nodes 7 shown in FIG. 3a, in design A, in which a plurality of intermediate network nodes 7 are connected between two NBCS reference clocks 8, produces a particularly long transit time delay. It is furthermore evident that transit time delays occur which do not fall below an amount of 1 ms. The highest frequency of occurrence of transit time variances can be found at 10 ms. The frequency of data packets transported for 100 ms in the data network 4 is also still very high, so that this design appears to be unusable for transporting voice packets, even with the use of high-quality error-correction mechanisms.

FIG. 3c furthermore shows the delay variance in an arrangement of the network nodes 7 and the NBCS reference clocks 8 according to design B (FIG. 2c). In contrast to the first design, the data packets are forwarded much more frequently via NBCS reference clocks 8 in this arrangement. The frequency of occurrence of data packets with very much shorter transit times can thus be observed. In this design, no transit times below 0.1 ms occur, the most frequent transit time is 1 ms, and no transit times longer than 100 ms are measured.

Finally, curve C in FIG. 3c (schematically) shows the transit time variance of data packets which are transported via an arrangement of network nodes shown in FIG. 3b. This arrangement is set up in such a way that the data packets are transported via network nodes which in each case contain an NBCS reference clock. Due to this design, the transit time of the data packets, as shown in the diagram in FIG. 3c, is very much shorter and remains constant at 0.01 ms.

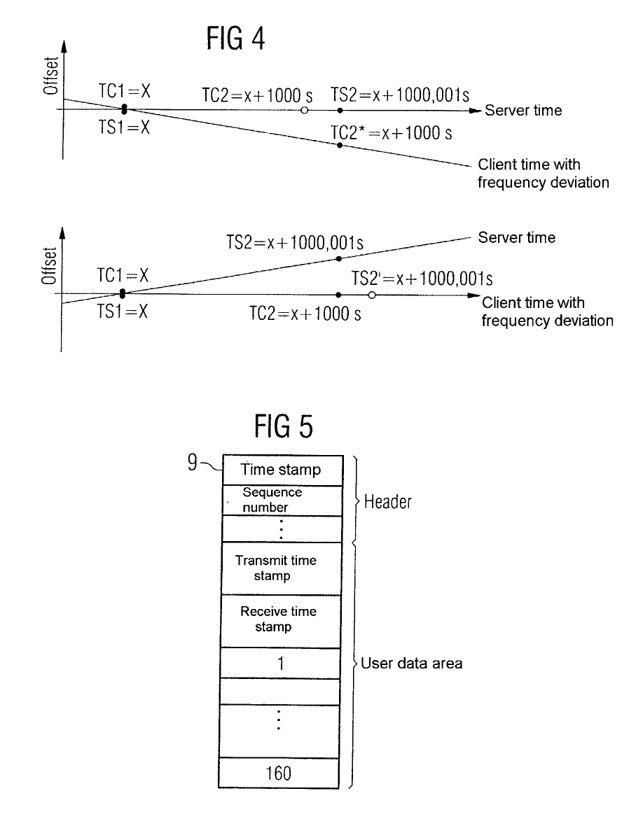

FIG. 4 shows two diagrams to explain a frequency deviation of a time-measuring device disposed within the transceiver device 5, 5′. If two clocks are compared with one another, they are measured from either the transmit device or the receive device. In the example shown in FIG. 4, the receive device measures the time of the transmit device after 1000 seconds: TS2=x+1000.001 s. The signal from the transmit device may therefore have required a maximum of 1 ms, or the time-measuring device within the transmit device is a maximum of 1 ppm faster than the measuring device disposed within the receive device.

If, on the other hand, the times are viewed from the perspective of the transmit device, the time from the receive device is observed as TC2=x+1000 s. Since the signal from the receive device to the transmit device requires a finite time (a negative time delay can be physically excluded), this can therefore only involve a frequency deviation of the time-measuring device disposed within the receive device which, in this example, is at least 1 ppm slower than the time-measuring device of the transmit device.

In order to readjust the time-measuring device of the receive device quickly and reliably, suitably designed measuring devices are provided in both the receive and the transmit device. The setting data (tracking data) calculated within the transmit device are then transmitted as an identifier to the receive device, and a tracking device disposed within this device tracks the system time of the time-measuring device according to the identifier.

FIG. 5 shows an extended RTP data packet 9 encapsulated within an IP data packet. RTP provides services for transmitting real-time data between end points of a unicast or multicast environment. These services include identification of transmitted user data and their sources, allocation of sequence numbers and time stamps to data packets, monitoring of available Quality of Service (QoS), and transmission of information relating to subscribers.

An RTP data packet comprises a 12-byte header, followed by a user data area which is filled with user data (audio, video, data). One byte in the header is provided specifically for payload-type identification. A sequence number is incremented by a fixed value for each transmitted RTP data packet, so that the receive device can identify the original sequence designation (and even possible packet losses) with the aid of this number. A time stamp likewise contained in the header is used for synchronization within a data stream. This time stamp therefore describes a data packet transmit time. A plurality of consecutive RTP data packets have the same time stamp if they are temporally interrelated.

In a preferred design of the method according to the invention, the extended RTP data packet 9 shown in FIG. 5 is used. A time stamp received by the receive station, a time stamp defined on reception and a time stamp generated on transmission are also added to the user data area of the data packet. The absolute accuracy of the time stamps should be greater than 125 microseconds.

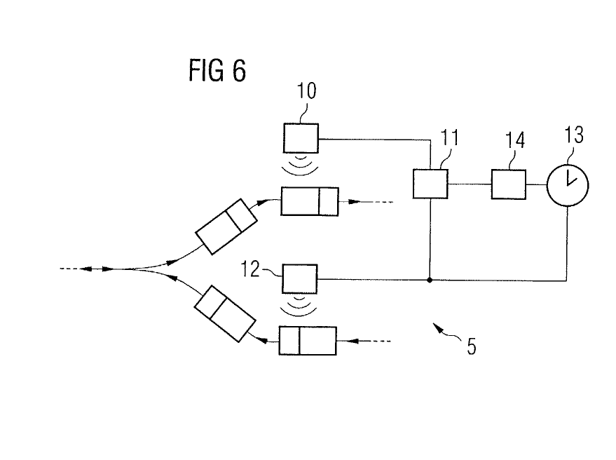

FIG. 6 shows a transceiver device 5 to carry out the method. A receive protocol device 10 reads a time stamp contained within a redundant area of the extended RTP data packet 9 which was generated when this data packet was transmitted, and transmits an identifier depending on this time stamp to a measuring device 11. A transmit protocol device 12 adds a transmit time stamp to the redundant area of an RTP data packet 9 which is to be transmitted. This stamp contains a transmit time identifier generated by a time-measuring device 13 depending on the system time. This identifier is similarly fed to the measuring device 11. A time stamp received by a remote station, the time stamp defined on reception, and the time stamp generated on transmission are thus added to the redundant data area of the RTP data packet 9. The absolute accuracy of the time stamps should be greater than 125 microseconds. Within the measuring device 11, a possible frequency deviation of the time-measuring device 13 is measured depending on the time stamps and correspondingly identified, and this identifier is fed to a tracking unit 14. This tracking unit 14 then tracks the system time of the time-measuring device 13 depending on the frequency deviation identifier.

The design of the invention is not restricted to the example described and the aspects highlighted above, but rather a multiplicity of variations within the scope of the claims can similarly be conceived by a person skilled in the art.

The invention has been described in detail with particular reference to preferred embodiments thereof and examples, but it will be understood that variations and modifications can be effected within the spirit and scope of the invention.

What is claimed is:

1. A method for synchronizing a communication system via a packet-oriented data network by a measuring device for determining a frequency offset of a time-measuring device, comprising:
determining the frequency offset within the measuring device using only data packets with substantially identical forward and return times.

2. The method as claimed in claim 1, wherein said determining uses only data packets with a transit time of less than 5 ms.

3. The method as claimed in claim 2, further comprising transporting the data packets by transmit devices via at least one nearest NBCS reference clock in the network.

4. The method as claimed in claim 3, wherein said transporting uses an extended Real Time Transport Protocol.

5. The method as claimed in claim 4, further comprising adding a time stamp to each data packet by a receive protocol device disposed within a receive device to identify a receive time.

6. The method as claimed in claim 4, further comprising adding a time stamp to each data packet by a transmit protocol device disposed within a transmit device to identify a transmit time.

7. A transceiver device for synchronizing a communication system via a packet-oriented data network, comprising:
a transmit and receive protocol devices to identify a transmit time of a data packet by adding a respective time stamp to a data area of the data packet, said transmit protocol device including a time-measuring device;
a measuring device to determine a frequency offset of the time-measuring device disposed within said transceiver device; and
a tracking unit to track the time-measuring device depending on the frequency offset.

8. A network device for synchronizing a communication system via a packet-oriented data network, comprising:
at least one transport device, disposed within the network, to forward data packets to at least one nearest NBCS reference clock and to determine a frequency offset within the measuring device using only data packets with substantially identical forward and return times.

9. The network device as claimed in claim 8, wherein the packet-oriented data network is an Internet Protocol-based network.
